(19) United States
(12) Patent Application Publication
(10) Pub. No.: US 2009/0027577 A1
(43) Pub. Date: Jan. 29, 2009

(54) LIQUID CRYSTAL DISPLAY ELEMENT, ELECTRONIC PAPER HAVING THE SAME, AND IMAGE PROCESSING METHOD

(75) Inventor: Masaki NOSE, Kawasaki (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: FUJITSU LIMITED, Kawasaki-shi (JP)

(21) Appl. No.: 12/238,931

(22) Filed: Sep. 26, 2008

Related U.S. Application Data
(63) Continuation of application No. PCT/JP2006/306495, filed on Mar. 29, 2006.

(51) Int. Cl. G02F 1/133

(52) U.S. Cl. 349/33

(57) ABSTRACT

The liquid crystal display element includes a display unit having a liquid crystal layer forming a cholesteric phase and another liquid crystal layer formed on a display surface side of the liquid crystal layer. The element further includes a control unit for converting an input gray level value of input image data into a first display gray level value to generate first display image data to be displayed by the first liquid crystal layer and converting an input gray level value of the input image data into a second display gray level value different from the first display gray level value to generate second display image data to be displayed by the second liquid crystal layer.

### BACKGROUND

1. Field

The present invention relates to a liquid crystal display element having a plurality of liquid crystal layers formed one over another, electronic paper having such an element, and an image processing method.

2. Description of the Related Art

Recently, various enterprises and universities are actively working on the development of electronic paper. Promising applications of electronic paper include electronic books which are most promising, sub-displays of mobile terminals, and display sections of IC cards. One of display methods advantageously used in electronic paper is the use of a liquid crystal display element employing a cholesteric liquid crystal. A liquid crystal display element employing a cholesteric liquid crystal has advantageous features such as semi-permanent display retention characteristics (memory characteristics), the capability of displaying vivid colors, high contrast, and high resolution. A cholesteric liquid crystal is obtained by adding a relatively large amount (several tens percent) of chiral additive (a chiral material) to a nematic liquid crystal and is therefore also called a chiral nematic liquid crystal. A cholesteric liquid crystal forms a cholesteric phase in which nematic liquid crystal molecules have such a strong helical twist that incident light undergoes interference reflection.

A display element utilizing a cholesteric liquid crystal is enabled for display by controlling the alignment of liquid crystal molecules at each pixel of the element. The alignment of a cholesteric liquid crystal includes a planar state and a focal conic state. Those states stably exist even when no electric field is applied to the element. A liquid crystal layer in the focal conic state transmits light, and a liquid crystal layer in the planar state selectively reflects light having particular wavelengths according to the helical pitch of the liquid crystal molecules.

FIGS. 1A and 1B schematically show sectional configurations of a liquid crystal display element employing a cholesteric liquid crystal. FIG. 1A shows a sectional configuration of the liquid crystal display element in the planar state, and FIG. 1B shows a sectional configuration of the liquid crystal display element in the focal conic state. As shown in FIGS. 1A and 1B, a liquid crystal display element 146 has a pair of substrates, i.e., a top substrate 147 and a bottom substrate 149, and a liquid crystal layer 143 formed by enclosing a cholesteric liquid crystal between the top substrate 147 and the bottom substrate 149.

As shown in FIG. 1A, liquid crystal molecules 133 in the planar state form a helical structure in which helical axis of the molecules is substantially perpendicular to substrate surfaces. In the planar state, the liquid crystal layer 143 selectively reflects light having predetermined wavelengths according to the helical pitch of the liquid crystal molecules 133. Therefore, when the liquid crystal layer 143 at a certain pixel is put in the planar state, the pixel enters a bright state. A wavelength λ which undergoes the greatest reflection is expressed by λ=n·p where n represents the average refractive index of the liquid crystal and p represents the helical pitch of the same. A reflection bandwidth Δλ increases with refractive index anisotropy Δn of the liquid crystal.

As shown in FIG. 1B, the liquid crystal molecules 133 in the focal conic state form a helical structure in which the helical axis of the molecules is substantially parallel to the substrate surfaces. In the focal conic state, the liquid crystal layer 143 transmits most of light rays incident on the same. Therefore, when the liquid crystal layer 143 is put in the focal conic state at a certain pixel, the pixel enters a dark state. Black can be displayed in the focal conic state by disposing a visible light absorbing layer on the bottom of the bottom substrate 149.

FIG. 2 schematically shows a sectional configuration of a common color liquid crystal display element employing a cholesteric liquid crystal. As shown in FIG. 2, the color liquid crystal display element has a configuration in which a liquid crystal layer (a blue layer) 101B for displaying blue (B), a liquid crystal layer (a green layer) 101G for displaying green (G), and a liquid crystal layer (a red layer) 101R for displaying red (R) are stacked in the order listed, for example, starting at a display surface side (top side of FIG. 2). In general, a liquid crystal layer reflects light having shorter wavelengths, the higher the chiral material content of the same. Specifically, in the case of the color liquid crystal display element shown in FIG. 2, the liquid crystal layer 101B has the highest chiral material content, and the liquid crystal molecules in the later have a strong twist and therefore have a short helical pitch. In general, a liquid crystal layer tends to require a higher drive voltage, the higher the chiral material content of the layer.

FIG. 3 shows examples of reflection spectra of the liquid crystal display element. The horizontal axis of the figure represents wavelengths (in nm), and the vertical axis represents reflectance (in percents). The curve connecting black triangular symbols represents a reflection spectrum obtained at the liquid crystal layer 101B. The curve connecting black square symbols represents a reflection spectrum obtained at the liquid crystal layer 101G. The curve connecting black rhombic symbols represents a reflection spectrum obtained at the liquid crystal layer 101R. The maximum reflectance of a liquid crystal layer in the planar state is theoretically 50% and about 40% in practice because the layer selectively reflects either left circularly polarized light or right circularly polarized light. The liquid crystal layers 101R, 101G, and 101B are provided with different helical pitches of liquid crystal molecules such that the layers selectively reflect red, green, and blue, respectively. As a result, the liquid crystal display element formed by stacking the three liquid crystal layers 101R, 101G, and 101B is capable of color display.

However, color liquid crystal display elements employing a cholesteric liquid crystal have had a problem in that they are not necessarily highly evaluated compared to other types of display elements from the viewpoint of balance of color reproduction ranges and contrast. One possible reason for this problem is a reflection loss or reflection noise which can occur in light reflected by a liquid crystal layer disposed in a low part of such an element. FIG. 4 is an illustration for explaining a problem in a color liquid crystal display element employing a cholesteric liquid crystal. Similarly to the liquid crystal display element shown in FIG. 2, the color liquid crystal display element shown in FIG. 4 includes a liquid crystal layer 101B for displaying blue, a liquid crystal layer 101G for displaying green, and a liquid crystal layer 101R for displaying red which are formed one over another in the order listed from the display surface side of the element. Assuming that the liquid crystal layers 101B and 101G are in the focal conic state and that the liquid crystal layer 101R is in the planar state, light which has entered the element from the display surface side is transmitted through the liquid crystal layers 101B and 101G and reflected by the liquid crystal layer 101R. A significant reflection loss occurs in the light reflected by the liquid crystal layer 101R because of scattering at the liquid crystal layers 101G and 101B located closer to the display surface than the liquid crystal layer 101R and interfacial reflections at interfaces located closer to the display surface than the liquid crystal layer 101R. Since such a reflection loss reduces the color purity of red and contrast, the vividness of the displayed image will be low, and display quality will therefore be degraded.

The same problem occurs in the liquid crystal layer 101G located closer to the display surface than the liquid crystal layer 101R, although the problem is not as significant as in the liquid crystal layer 101R. Specifically, when the liquid crystal layers 101B and the 101R are in the focal conic state and the liquid crystal layer 101G is in the planar state, light which has entered the element from the display surface side is transmitted by the liquid crystal layer 101B and reflected by the liquid crystal layer 101G. A reflection loss occurs in the light reflected by the liquid crystal layer 101G because of scattering at the liquid crystal layer 101B located closer to the display surface than the liquid crystal layer 101G and interfacial reflections at interfaces located closer to the display surface than the liquid crystal layer 101G. Since the liquid crystal layer 101B is located closest to the display surface in the configuration shown in FIG. 4, color reproducibility is highest for blue.

### SUMMARY OF THE INVENTION

According to an aspect of the invention, a liquid crystal display element includes a display unit having a first liquid crystal layer forming a cholesteric phase and a control unit generating first display image data to be displayed by the first liquid crystal layer by converting an input gray level value of input image data into a first display gray level value.

### BRIEF DESCRIPTION OF THE DRAWINGS

FIGS. 1A and 1B schematically show sectional configurations of a liquid crystal display element employing a cholesteric liquid crystal;

FIG. 2 schematically shows a sectional configuration of a color liquid crystal display element employing a cholesteric liquid crystal;

FIG. 3 is a graph showing an example of reflection spectra of a liquid crystal display element having a multi-layer structure;

FIG. 4 is an illustration for explaining a problem in a color liquid crystal display element employing a cholesteric liquid crystal;

FIG. 5 is a graph showing an example of R, G, and B tone curves of a liquid crystal display element in an embodiment;

FIG. 6 is a graph showing another example of R, G, and B tone curves of the liquid crystal display element of the embodiment;

FIG. 7 is a graph showing a relationship between temperature and scattering of light in a liquid crystal layer in a focal conic state;

FIGS. 8A to 8C are graphs showing examples of R, G, and B tone curves obtained at different temperatures;

FIG. 9 is a block diagram showing a schematic configuration of the liquid crystal display element of the embodiment;

FIG. 10 is a sectional view schematically showing a configuration of the liquid crystal display element of the embodiment;

FIG. 11 is a block diagram schematically showing a configuration of a calculation section and a flow of processes performed by the calculation section;

FIGS. 12A and 12B show voltage waveforms in one selection period applied to a signal electrode;

FIGS. 13A and 13B show voltage waveforms in one selection period applied to a scan electrode;

FIGS. 14A and 14B show voltage waveforms in one selection period applied to a liquid crystal layer at a pixel;

FIG. 15 is a graph showing an example of voltage-reflectance characteristics of a cholesteric liquid crystal;

FIGS. 16A to 16C are graphs for explaining effects of the liquid crystal display element of the embodiment; and

FIG. 17 is a block diagram schematically showing a configuration of a calculation section of a liquid crystal display element according to a modification of the embodiment of the invention and a flow of processes performed by the calculation section.

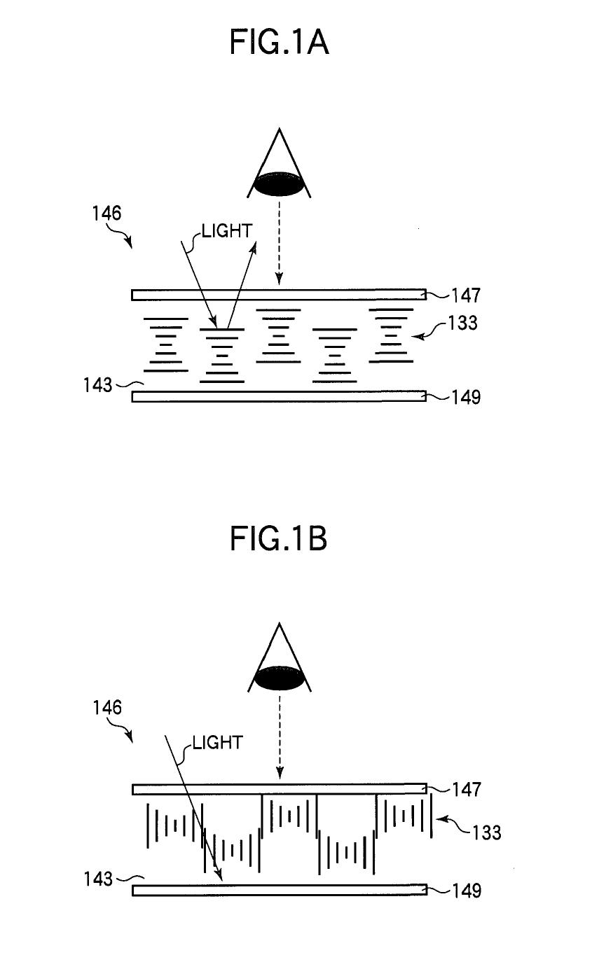

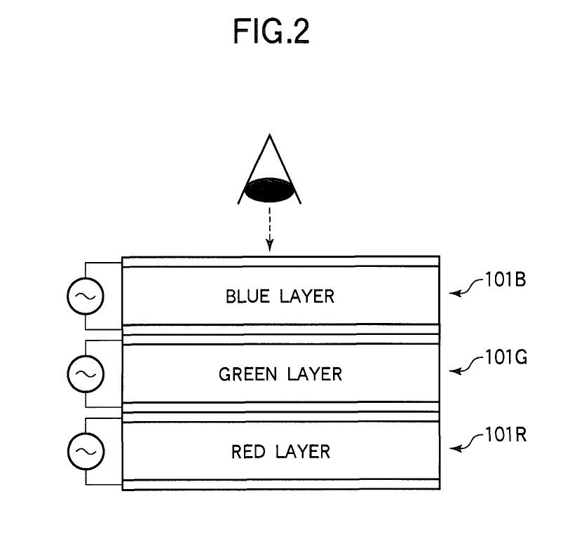

### DETAILED DESCRIPTION OF THE PREFERRED EMBODIMENTS

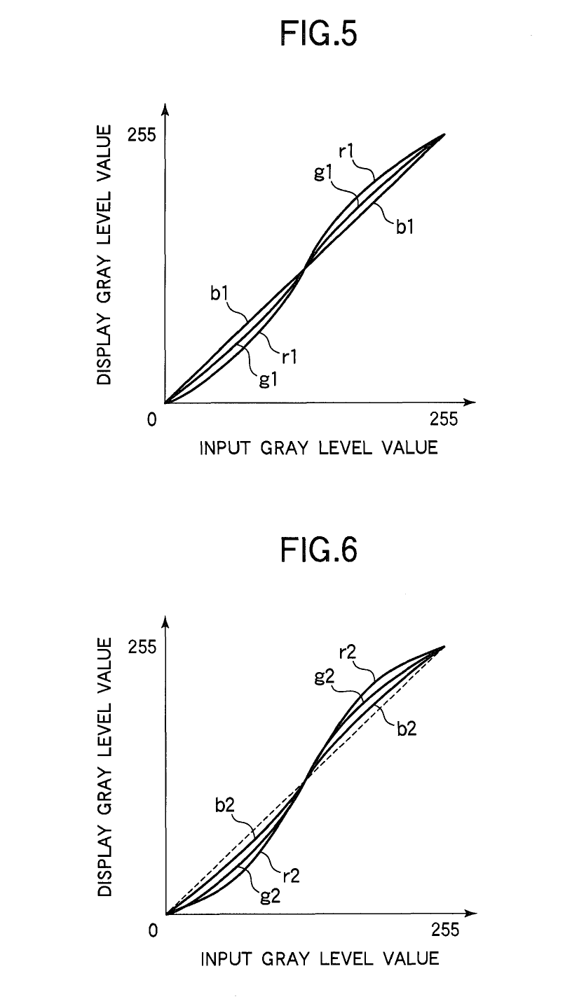

A description will now be made with reference to FIGS. 5 to 17 on a liquid crystal display element, electronic paper having such an element, and image processing method according to an embodiment. First, the principle of the liquid crystal display element and the image processing method of the present embodiment will be described. FIG. 5 shows an example of tone curves representing a relationship between input gray level values and display gray level values of the liquid crystal display element in the present embodiment. The horizontal axis represents input gray level values (e.g., gray levels 0 to 255) included in image data input to the liquid crystal display element from the outside. The vertical axis represents display gray level values (e.g., gray levels 0 to 255) included in display image data obtained by converting the input gray level values. The curve r1 represents a tone curve of red. The curve g1 represents a tone curve of green. The curve b1 represents a tone curve of blue. The liquid crystal display element has a configuration in which a display layer for displaying blue (B), a display layer for displaying green (G), and a display layer for displaying red (R) are formed one over another in the order listed starting at a display surface side of the element.

As shown in FIG. 5, the B tone curve (curve b1) is a substantially straight line which monotonously ascends, and B display gray level values are substantially the same as input gray level values from which they are converted. On the contrary, the R and G tone curves (curves g1 and r1) are curves bulging upward on a high gray level side thereof and bulging downward on a low gray level side thereof, although the curves also monotonously ascend. Most of R and G display gray level values are different from input gray level values from which they are converted. G display gray level values converted from input gray level values on the high gray level side (highlight side where gray level values are, for example, in the range from 128 to 254) are higher than the input gray level values (and B display gray level values obtained by converting the same input gray level values). R display gray level values converted from the input gray level values on the high gray level side are higher than the G display gray level values obtained by converting the same input gray level values. Therefore, color components of a display layer of the liquid crystal display element are more strongly corrected in the direction of enhancing chroma (color purity), the lower the display layer is disposed in the element. All of the R, G, and B display gray level values obtained by converting the maximum input gray level value (gray level 255) are at the maximum (gray level 255).

G display gray level values converted from input gray level values on the low gray level side (shadow side where gray level values are, for example, in the range from 1 to 126) are lower than the input gray level values (and B display gray level values obtained by converting the same input gray level values). R display gray level values converted from the input gray level values on the low gray level side are lower than the G display gray level values obtained by converting the same input gray level values. Therefore, color components of a display layer of the liquid crystal display element are more strongly corrected in the direction of enhancing contrast, the lower the display layer is disposed in the element. All of the R, G, and B display gray level values obtained by converting the minimum input gray level value (gray level 00) are at the minimum (gray level 0).

In the present embodiment, darkening of intermediate gray levels of red displayed by the display layer located at the bottom of the liquid crystal display element is mitigated. Therefore, the display element is capable of displaying a memorized color such as flesh color (pale orange) even when the color reproduction range of the same is limited like when incorporated in electronic paper.

FIG. 6 shows other examples of R, G, and B tone curves of the liquid crystal display element in the present embodiment, the curves being shown in an overlapping relationship. The horizontal and vertical axes represent the same things as those in FIG. 5. The curve r2 represents an R tone curve. The curve g2 represents a G tone curve. The curve b2 represents a B tone curve. As shown in FIG. 6, all of the R, G, and B tone curves (curves r2, g2, and b2) of this example are curves bulging upward on a high gray level side thereof and bulging downward on a low gray level side thereof. R, G, and B display gray level values obtained by converting input gray level values on the high gray level side are all higher than the input gray level values. The G display gray level values are higher than the B display gray level values converted from the same input gray level values on the high gray level side, and the R display gray level values are higher than the G display gray level values converted similarly. Thus, color components of a display layer of the liquid crystal display element are more strongly corrected in the direction of enhancing chroma, the lower the layer is disposed in the element. In addition, the chroma of color components of the display layer disposed closest to the display surface is enhanced.

R, G, and B display gray level values obtained by converting input gray level values on the low gray level side are all lower than the input gray level values. The G display gray level values are lower than the B display gray level values converted from the same input gray level values on the low gray level side, and the R display gray level values are lower than the G display gray level values converted similarly. Thus, color components of a display layer of the liquid crystal display element are more strongly corrected in the direction of enhancing contrast, the lower the layer is disposed in the element. In addition, the contrast of color components of the display layer disposed closest to the display surface is enhanced.

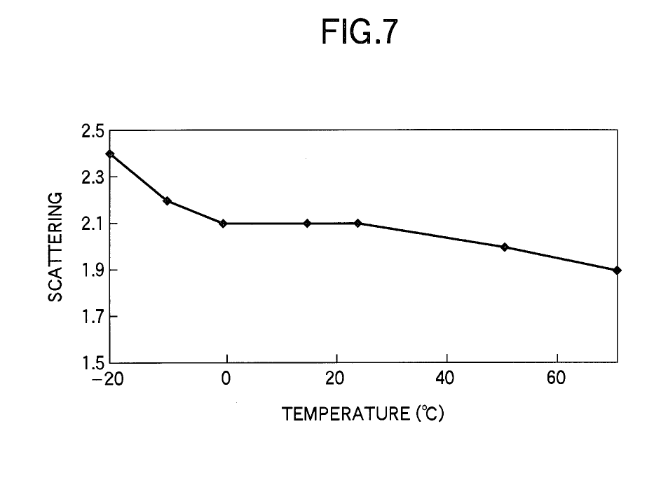

The inventors found that it is more advantageous to adjust the degree of enhancement in chroma and contrast as described above according to temperature. FIG. 7 is a graph showing a relationship between temperatures and scattering of light in a liquid crystal layer in the focal conic state. The horizontal axis represents temperatures (in ° C.), and the vertical axis represents scattering of light. A large percentage of the scattering is occupied by “Backward scattering” of light incident upon the liquid crystal layer in the focal conic state. Scattering is shown in FIG. 7 in the form of measured values of reflectance of the layer in the focal conic state (in ratios (%) to that of a white plate). As shown in FIG. 7, scattering of light in the liquid crystal layer in the focal conic state is more significant in general, the lower the temperature. At low temperatures, a color displayed by a lower layer of a liquid crystal display element is therefore strongly affected by scattering of light in the liquid crystal layer above the same, and this results in a further reduction in the color purity of the color displayed by the lower layer. In addition, since the density of black is reduced (the luminance of black increases), a significant reduction in contrast also occurs.

The balance of a color reproduction range and the contrast significantly depend on scattering of light in the liquid crystal layer in the focal conic state. For example, when a single color, i.e., red, green, or blue is to be displayed, one liquid crystal layer enters the planar state, and the two remaining liquid crystal layers enter the focal conic state. At this time, if there is significant scattering of light in the liquid crystal layers in the focal conic state, the scattering light is superimposed as noise on light reflected by the liquid crystal layer in the planar state, and this results in a reduction in color purity. When black is displayed, all of the liquid crystal layers are in the focal conic state. When there is significant scattering of light in the liquid crystal layers in this state, the density black will be significantly reduced.

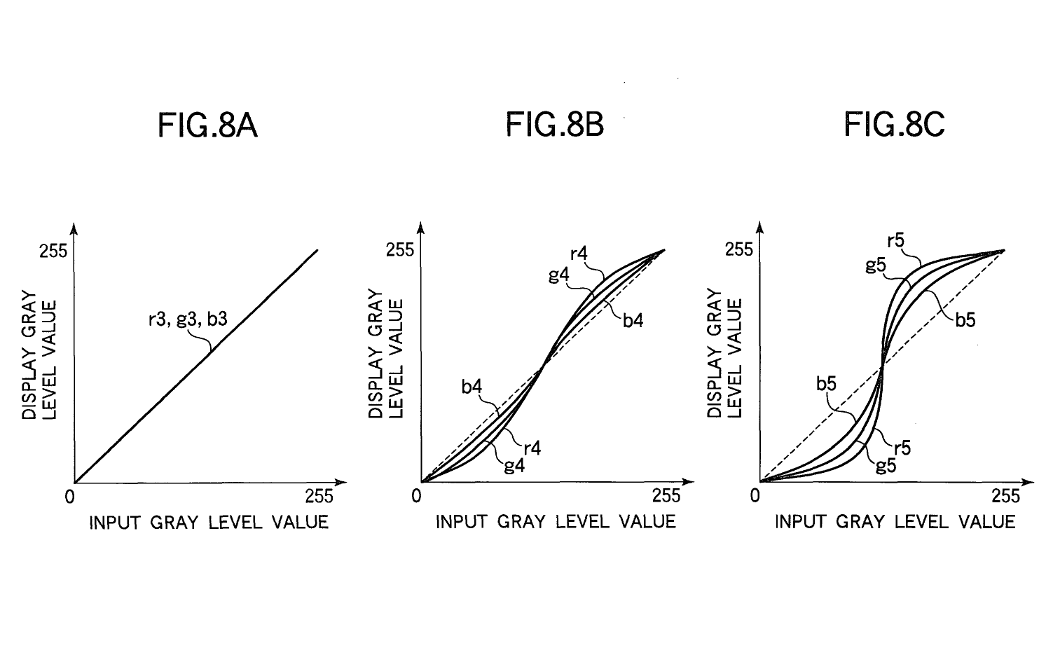

Under the circumstance, in the present embodiment, the degree of enhancement of chroma and contrast is adjusted by, for example, the temperature in the neighborhood of a display unit. FIGS. 8A to 8C show examples of R, G, and B tone curves obtained at different temperatures. FIG. 8A shows tone curves obtained at temperatures in the neighborhood of the display unit which are somewhat higher than the room temperature (about 20 to 30° C.). FIG. 8B shows tone curves obtained at temperatures in the neighborhood of the display unit which are on the level of the room temperature. FIG. 8C shows tone curves obtained at temperatures in the neighborhood of the display unit which are somewhat lower than the room temperature. In FIGS. 8A to 8C, the horizontal and vertical axes represent the same things as those in FIG. 5. Each of the curves r3, r4, and r5 represents an R tone curve. Each of the curves g3, g4, and g5 represents a G tone curve. Each of the curves b3, b4, and b5 represents a B tone curve.

When the temperature in the neighborhood of the display unit is high, scattering of light in a liquid crystal layer in the focal conic state is relatively less significant, and it is not necessarily required to enhance chroma and contrast. Therefore, as shown in FIG. 8A, all of R, G, and B display gray level values are substantially equal to the input gray level values from which they are converted.

When the temperature in the neighborhood of the display unit is on the level of the room temperature, scattering of light in a liquid crystal layer in the focal conic state is more significant compared to that at the higher temperatures. It is therefore preferable to convert input gray level values into display gray level values such that chroma and contrast will be enhanced as shown in FIG. 8B. For example, input gray level values on the high gray level side are converted into G display gray level values higher than B display gray level values obtained by converting the same input gray level values, and R display gray level values obtained by converting the same input gray level values are higher than the G display gray level values. Input gray level values on the low gray level side are converted into G display gray level values lower than B display gray level values obtained by converting the same input gray level values, and R display gray level values obtained by converting the same input gray level values are lower than the G display gray level values.

At the low temperatures in the neighborhood of the display unit, there is more significant scattering of light in a liquid crystal layer in the focal conic state. It is therefore preferable to convert input gray level values into display gray level values such that chroma and contrast will be more strongly enhanced as shown in FIG. 8C. For example, R, G, and B display gray level values obtained by converting the same input gray level values on the high gray level side are higher than respective R, G, and B display gray level values (see FIG. 8B) obtained when the temperature in the neighborhood of the display unit is on the level of the room temperature. R, G, and B display gray level values obtained by converting the same input gray level values on the low gray level side are lower than respective R, G, and B display gray level values obtained when the temperature in the neighborhood of the display unit is on the level of the room temperature.

As thus described, any reduction in chroma and constrast attributable to scattering of light in a liquid crystal layer in the focal conic state can be preferably mitigated by enhancing chroma and contrast more strongly, the lower the temperature in the neighborhood of the display unit. As a result, high display quality can be achieved regardless of the temperature of the environment in which the liquid crystal display element is used.

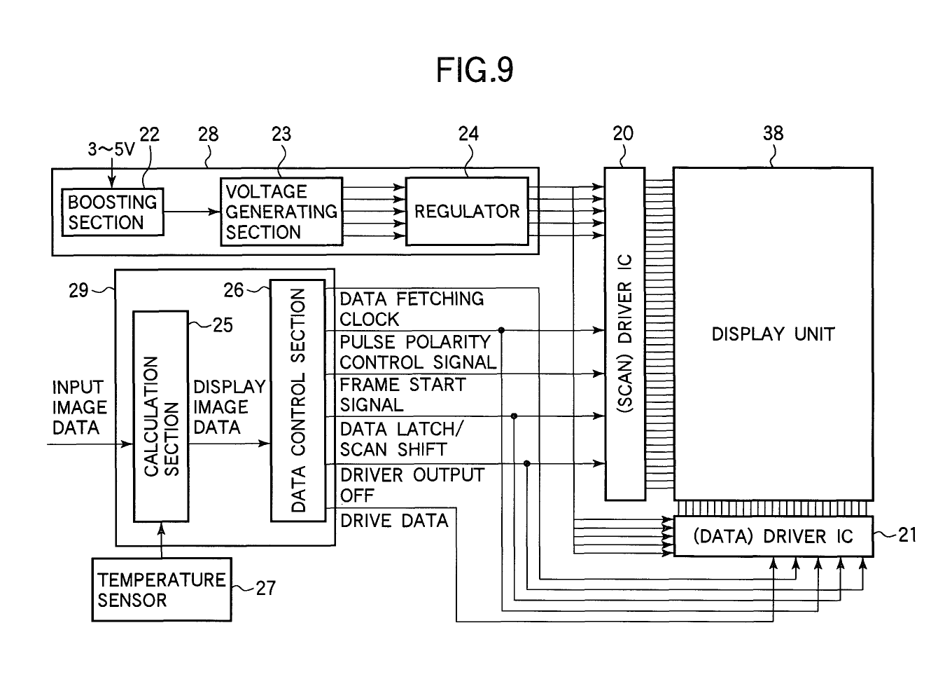

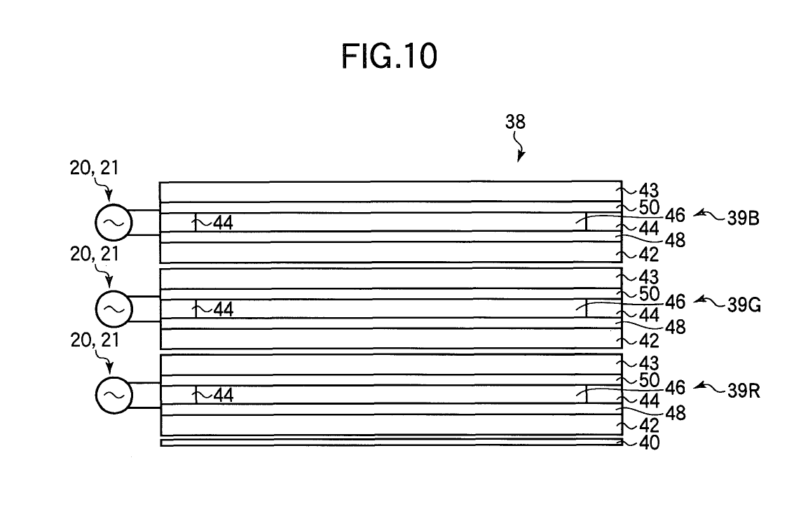

FIG. 9 is a block diagram showing a schematic configuration of the liquid crystal display element of the present embodiment. FIG. 10 is a sectional view of the liquid crystal display element schematically showing a configuration of the same. As shown in FIGS. 9 and 10, the liquid crystal display element includes a display unit 38 having memory characteristics. The display unit 38 includes a display layer 39B for displaying blue, a display layer 39G for displaying green, and a display layer 39R for displaying red, those layers being formed one over another starting at a display surface side (top side of FIG. 10) of the element. Further, a visible light absorbing layer 40 is provided as occasion demands on the bottom of the display layer 39R (bottom side of FIG. 10).

Each of the display layers 39R, 39G, and 39B has a pair of substrates 42 and 43 which are combined with a seal material 44 interposed between them. For example, both of the substrates 42 and 43 have translucency which allows visible light to pass the substrates. Glass substrates or film substrates made of poly ethylene terephthalate (PET) or poly carbonate (PC) may be used as the substrates 42 and 43.

A plurality of scan electrodes 48 in the form of strips extending substantially in parallel with each other are formed on a surface of the substrate 42 facing the substrate 43. A plurality of signal electrodes 50 in the form of strips extending substantially in parallel with each other are formed on a surface of the substrate 43 facing the substrate 42. When the display layers are Q-VGA graphic mode, for example, 240 scan electrodes 48 and 320 signal electrodes 50 are formed. The scan electrodes 48 and the signal electrodes 50 extend so as to cross each other when viewed in a direction perpendicular to the substrate surfaces. A plurality of regions where the scan electrodes 48 and the signal electrodes 50 intersect each other constitute a plurality of pixel regions which are disposed in the form of a matrix. For example, the scan electrodes 48 and the signal electrodes 50 are formed from an indium tin oxide (ITO). The scan electrodes 48 and the signal electrodes 50 may alternatively be formed by transparent conductive films made of an indium zinc oxide (IZO), metal electrode films made of aluminum or silicon, or photo-conductive films made of amorphous silicon or a bismuth silicon oxide (BSO).

The scan electrodes 48 and the signal electrodes 50 are preferably coated with an insulating thin film or alignment stabilizing film. An insulating thin film prevents shorting between the electrodes and serves as a gas barrier layer for blocking gas components, and the film therefore has the function of improving the reliability of the liquid crystal display layers. An organic film made of a polyimide resin, polyamide imide resin, polyether imide resin, polyvinyl butyral resin, or acryl resin or an inorganic material such as a silicon oxide or aluminum oxide may be used as the alignment stabilizing film. In the present embodiment, the scan electrodes 48 and the signal electrodes 50 are coated with an alignment stabilizing film. The alignment stabilizing film may be also used as an insulating thin film.

Spacers (not shown) for maintaining a uniform cell gap are provided between the substrates 42 and 43. The spacers may be spherical spacers made of a resin or inorganic oxide, fixed spacers coated with a thermoplastic resin on the surface thereof, or columnar spacers formed on the substrates using a photolithographic process.

A cholesteric liquid crystal compound having a cholesteric phase at the room temperature is enclosed between the substrates 42 and 43 to form liquid crystal layers 46. The cholesteric liquid crystal compound is obtained by adding 10 to 40% by weight of chiral material to a nematic liquid crystal mixture. The amount of the chiral material added is shown on an assumption that the total amount of the nematic liquid crystal and the chiral material is 100% by weight. When the chiral material is added in a greater amount, the helical pitch of the nematic liquid crystal becomes shorter because of a great twist given to the liquid crystal molecules, and the liquid crystal will selectively reflect light having shorter wavelengths in the planar state. On the contrary, when the chiral material is added in a smaller amount, the helical pitch becomes longer, and the liquid crystal will selectively reflect light having longer wavelengths in the planar state. The liquid crystal layer 46 of the display layer 39R selectively reflects light having the wavelength of red in the planar state. The liquid crystal layer 46 of the display layer 39G selectively reflects light having the wavelength of green in the planar state. The liquid crystal layer 46 of the display layer 39B selectively reflects light having the wavelength of blue in the planar state.

Known materials of various types may be used as the nematic liquid crystal. The cholesteric liquid crystal compound preferably has dielectric constant anisotropy Δε in the range from 20 to 50. When the dielectric constant anisotropy Δε is 20 or more, since any significant increase in a driving voltage can be suppressed, inexpensive general-purpose components can be used in driving circuits. When the dielectric constant anisotropy Δε of the cholesteric liquid crystal compound is lower than the above-described range, the driving voltage can become too high. Conversely, when the dielectric constant anisotropy Δε of the cholesteric liquid crystal compound is higher than the above-described range, the display element will be degraded in terms of stability and reliability, and the possibility of occurrence of image defects and image noises increases.

Refractive index anisotropy Δn of the cholesteric liquid crystal compound is an important solid-state property value dominating image quality. Refractive index anisotropy Δn in the range of about 0.18 to 0.24 is preferable. Refractive index anisotropy Δn smaller than this range results in a reduction in the refractive index in the planar state and consequently results in a reduction in display luminance. Conversely, refractive index anisotropy Δn greater than the range results in an increase in light scattering in the focal conic state. As a result, color purity and contrast is reduced, which can result in blurred display. The cholesteric liquid crystal compound preferably has a specific resistance in the range from 10¹⁰ to 10¹³ Ω·cm. A voltage increase or a reduction in contrast at low temperatures is more effectively suppressed, the lower the viscosity of the cholesteric liquid crystal compound. It is desirable that the cholesteric liquid crystal compound has viscosity in the range from 20 to 1200 mPa·s from the view point of the response speed and stability of alignment of the liquid crystal.

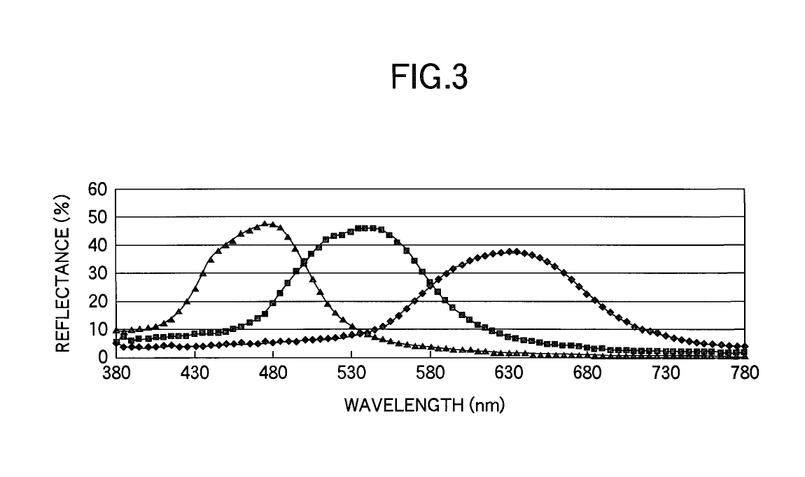

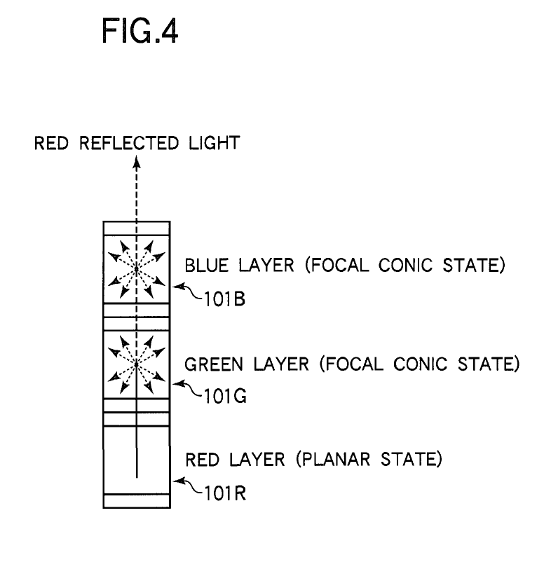

In the present embodiment, optical rotatory in the liquid crystal layer 46 of the display layer 39G in the planar state is made different from the optical rotatory in the liquid crystal layers 46 of the display layers 39R and 39B. As a result, in a region where B and G reflection spectra overlap each other and a region where G and R reflection spectra overlap each other as shown in FIG. 3, right circularity polarized light can be reflected by the liquid crystal layer 46 of the display layer 39B, and left circularly polarized light can be reflected by the liquid crystal layer 46 of the display layer 39G. It is therefore possible to achieve improved brightness on the display screen of the liquid crystal display element while suppressing loss of reflected light.

Like STN mode liquid crystal display elements, the present liquid crystal display element has scan side driver ICs 20 and data side driver ICs 21 each of which is connected to the display unit 38. In a liquid crystal display element including a plurality of display layers 39R, 39G, and 39B formed one over another as in the present embodiment, it is required in general to provide an independent data side driver IC 21 for each of the layers. On the contrary, a common scan side driver IC may be shared between the layers.

Further, the liquid crystal display element includes a power supply unit 28 having a boosting section 22, a voltage generating section 23, and a regulator 24. For example, the boosting section 22 includes a DC-DC converter and boosts a voltage of 3 to 5 VDC input from the outside to a voltage of about 30 to 40 V required for driving the cholesteric liquid crystal. The voltage generating section 23 generates a plurality of voltage levels required for generating different gray level values at various pixels and switching the pixels between selected and un-selected states. The regulator 24 includes a Zenner diode and an operational amplifier to stabilize voltages generated by the voltage generating section 23 and supply them to the driver ICs 20 and 21.

The liquid crystal display element includes a temperature sensor (ambient temperature detecting unit) 27. The temperature sensor 27 is provided, for example, in the vicinity of the display unit 38 to detect the temperature in the neighborhood of the display unit 38 and to output temperature data based on the detected temperature.

The liquid crystal display element further includes a control unit 29 having a calculation section 25 and a data control section 26. The calculation section 25 receives input image data from the outside and receives the data of the temperature in the neighborhood of the display unit 38 input from the temperature sensor 27. The temperature data may alternatively be input to the calculation section 25 from the outside. In this case, there is no need for providing the temperature sensor 27 on the liquid crystal display element. Based on the input image data and the temperature data, the calculation section 25 generates display image data to be displayed by each of the display layers 39R, 39G, and 39B of the display unit 38 and outputs the data to the data control section 26. The data control section 26 generates drive data based on display image data for each of the display layers 39R, 39G, and 39B input from the calculation section 25 and preset drive waveform data. The data control section 26 outputs the drive data thus generated to the data side driver ICs 21 according to a data fetching clock. The data control section 26 also outputs control signals such as pulse polarity control signals, frame start signals, data latch/scan shift signals, and driver output turn-off signals to the driver ICs 20 and 21.

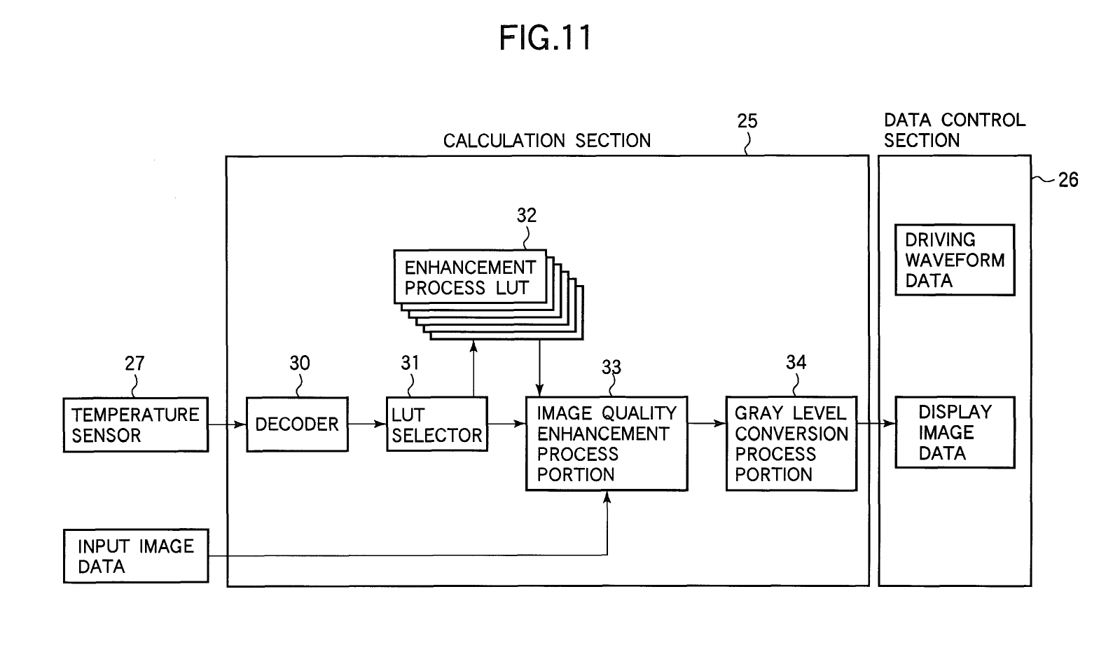

FIG. 11 is a block diagram schematically showing a configuration of the calculation section 25 and a flow of the processes performed by the calculation section 25. As shown in FIG. 11, a value output by the temperature sensor 27 is input to a decoder 30 of the calculation section 25. The decoder 30 converts the value output by the temperature sensor 27 into predetermined temperature data and outputs the data to a lookup table (LUT) selector 31. When the output from the temperature sensor 27 is a digital signal, the decoder 30 performs encoding in accordance with the LUT selector. When the output from the temperature sensor 27 is an analog signal, the decoder 30 is provided with functions of an A-D converter. The LUT selector 31 selects an optimal enhancement process LUT based on the temperature data supplied by the decoder from an LUT memory 32 in which image correction (enhancement process) LUTs are stored. The enhancement process LUT thus selected includes data of tone curves as shown in FIGS. 8A to 8C.

The input image data is input to an image quality enhancement process portion 33 of the calculation section 25. The image quality enhancement process portion 33 performs an image quality enhancement process for converting input gray level values in the input image data into display gray level values based on the enhancement process LUT selected by the LUT selector 31 to generate display image data to be displayed by each of the display layers 39R, 39G, and 39B. The image quality enhancement process portion 33 may perform the image quality enhancement process as a predetermined calculation process using the input image data instead of performing the process based on the enhancement process LUT.

The display image data thus generated may be subjected to a gray level conversion process at a gray level conversion process portion 34 if necessary. For example, the number of colors displayed by the display unit 38 is 512, the number of gray levels that each of the display layers 39R, 39G, and 39B can display is 8. When the input image is a full-color image (all of R, G, and B have 256 gray levels (8 bits)) in such a situation, a gray level conversion process must be performed in accordance with the number of displayable gray levels. Although the dot method or systematic dithering is also available as gray level conversion algorithm, the error diffusion method is advantageous from the viewpoint of resolution and sharpness and is well-matched with a liquid crystal display element employing a cholesteric liquid crystal. The next preferable method is the blue noise masking method. The blue noise masking method is advantageous in that it allows process to be performed at a high speed, although image quality provided by the method is lower than that achievable with the error diffusion method. The image quality enhancement process and the gray level conversion process may be performed in an arbitrary order. However, when the gray level conversion process is performed after display image data is generated by image quality enhancement process, granularity and pseudo contours can be more effectively suppressed, which is advantageous in that gray levels can be more smoothly rendered.

When the number of gray levels of each color in the input image data agrees with the number of gray levels that the display layers 39R, 39G, and 39B can display, the gray level conversion process portion 34 may be deleted. For example, a gray level conversion process utilizing the error diffusion method may be performed in advance at a transmitter of image data before the image data is transmitted (distributed) to the liquid crystal display element. In such a case, when a gray level conversion process has already been performed on input image data, the image quality enhancement process is performed after the gray level conversion process. This approach is advantageous in that the cost required for providing the gray level conversion process portion 34 in the liquid crystal display element can be eliminated and in that the time required for input image data to be displayed after being input to the liquid crystal display element can be shortened, although there is a possibility of some reduction in image quality.

Although not shown, electronic paper according to the present embodiment is configured by providing a liquid crystal display element as described above with an input/output device and a controller for overall control of the electronic paper.

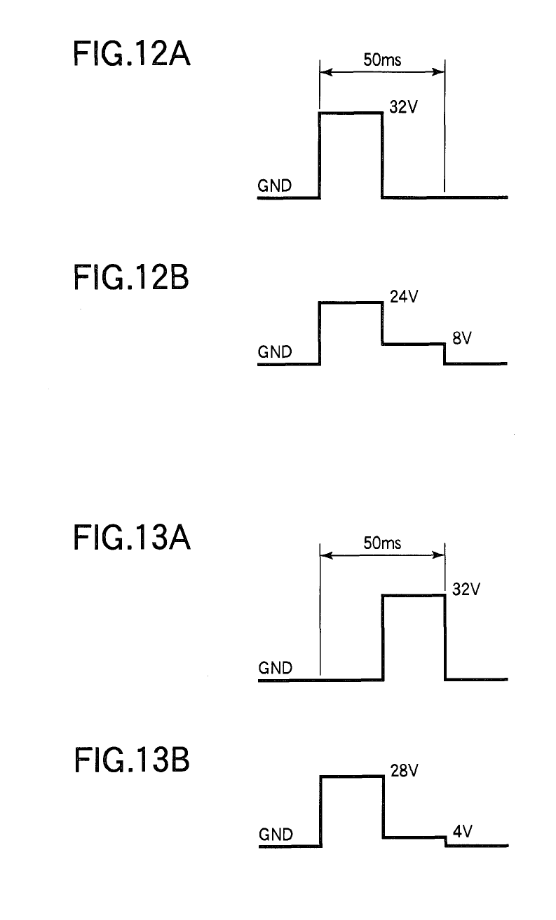

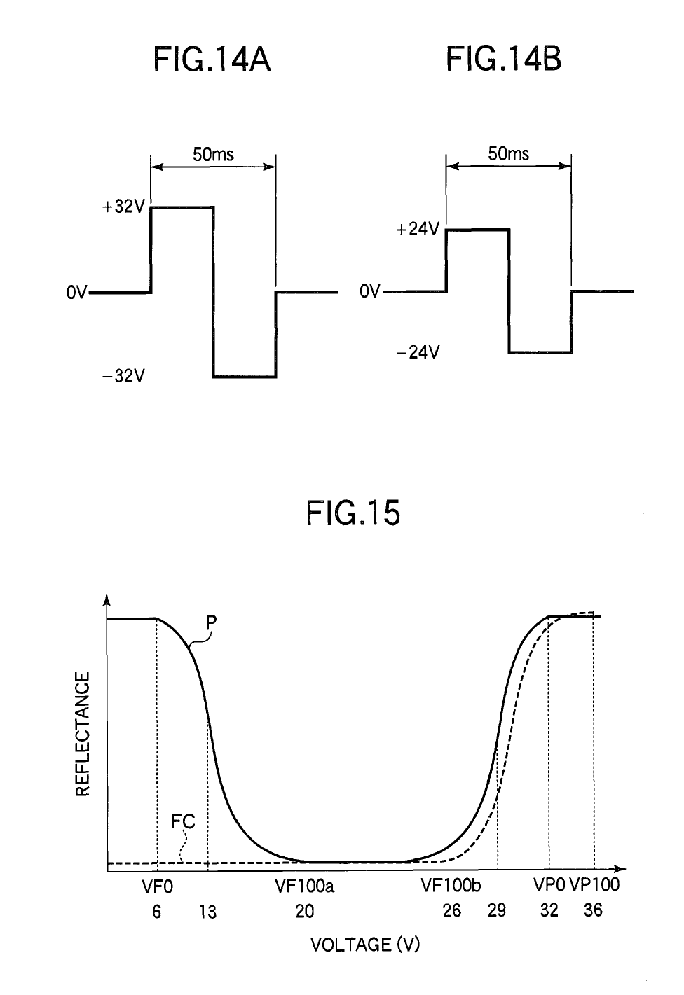

A method of driving the liquid crystal display element will now be described. FIG. 12A shows a waveform of a voltage applied from a driver IC 21 to a signal electrode 50 in one selection period to put the liquid crystal in the planar state based on drive data input from the data control section 26. The duration of such a selection period is in the range from several ms to several tens ms, although it depends on the material of the liquid crystal and the structure of the element. FIG. 12B shows a waveform of a voltage applied from a driver IC 21 to a signal electrode 50 to put the liquid crystal in the focal conic state. FIG. 13A shows a waveform of a voltage applied from a driver IC 20 to a selected scan electrode 48. FIG. 13B shows a waveform of a voltage applied from a driver IC 20 to an unselected scan electrode 48. FIG. 14A shows a waveform of a voltage applied to a liquid crystal layer 46 at a pixel that is driven into the planar state. FIG. 14B shows a waveform of a voltage applied to a liquid crystal layer 46 at a pixel that is driven into the focal conic state.

FIG. 15 is a graph showing an example of voltage-reflectance characteristics of the cholesteric liquid crystal. The horizontal axis represents values of voltages applied to a liquid crystal layer 46, and the vertical axis represents reflectance of the liquid crystal layer 46 after the voltages are applied. A state in which the reflectance of the liquid crystal layer 46 is relatively high represents the planar state, and a state in which the reflectance is relatively low represents the focal conic state. The curve P shown in a solid line in FIG. 15 represents voltage-reflectance characteristics of a liquid crystal layer 46 which is initially in the planar state. The curve FC shown in a broken line in the figure represents voltage-reflectance characteristics of a liquid crystal layer 46 which is initially in the focal conic state.

When a pixel is driven into the planar state, the voltage at the signal electrode 50 is +32 V as shown in FIG. 12A and the voltage at the scan electrode 48 is 0V as shown in FIG. 13A in the first half of the selection period. Therefore, a voltage of +32 V is applied to the liquid crystal layer 46 at the pixel as shown in FIG. 14A. In the second half of the selection period, the voltage at the signal electrode 50 becomes 0 V, and the voltage at the scan electrode 48 becomes +32 V. Therefore, a voltage of −32 V is applied to the liquid crystal layer 46 at the pixel. Since the maximum value of the voltage applied to the liquid crystal layer 46 in a non-selected period is ±4 V, a pulse voltage of substantially ±32 V is applied to the liquid crystal layer 46 at the pixel in the selected period. When an intense electric field is generated in the liquid crystal layer 46, the helical structure of the liquid crystal molecules is completely decomposed, and the liquid crystal enters a homeotropic state in which the directions of the longer axes of all liquid crystal molecules follow the direction of the electric field. When the electric field is abruptly removed in the homeotropic state, the helical axes of the liquid crystal become perpendicular to electrode surfaces, and the liquid crystal enters the planar state in which light having a wavelength in accordance with the helical pitch is selectively reflected. Specifically, the liquid crystal layer 46 enters the planar state when a pulse voltage of ±32 V (^{˜}VP0) is applied, and the pixel enters the bright state, as shown in FIG. 15.

When a pixel is driven into the focal conic state, the voltage at the signal electrode 50 is +24 V as shown in FIG. 12B and the voltage at the scan electrode 48 is 0 V as shown in FIG. 13A in the first half of the selection period. Therefore, a voltage of +24 V is applied to the liquid crystal layer 46 at the pixel as shown in FIG. 14B. In the second half of the selection period, the voltage at the signal electrode 50 becomes +8 V, and the voltage at the scan electrode 48 becomes +32 V. Therefore, a voltage of −24 V is applied to the liquid crystal layer 46 at the pixel. Since the maximum value of the voltage applied to the liquid crystal layer 46 in a non-selected period is +4 V, a pulse voltage of substantially ±24 V is applied to the liquid crystal layer 46 at the pixel in the selected period. When a relatively weak electric field such that the helical structure of liquid crystal molecules is not completely decomposed is generated in the liquid crystal layer 46 and is thereafter removed, the helical axes of the liquid crystal become parallel to the electrode surfaces, and the liquid crystal enters the focal conic state in which incident light is transmitted. Specifically, the liquid crystal layer 46 enters the focal conic state when a pulse voltage of ±24 V (<VF100b) is applied, and the pixel enters the dark state, as shown in FIG. 15.

A voltage value residing between VF100b (e.g., 26 V) and VP0 (e.g., 32 V) or a voltage value residing between VF0 (e.g., 6 V) and VF100a (e.g., 20 V) is used to display an intermediate gray level. When a pulse voltage having such a voltage value is applied, the liquid crystal enters a state of alignment that is a mixture of the planar state and the focal conic state, and an intermediate gray level can be displayed in such a state. When intermediate gray levels are displayed using voltages residing between VF0 and VF100a, high display quality can be achieved because the intermediate gray levels have less display irregularities, although there is a limitation that the initial state of the liquid crystal must be the planar state. When intermediate gray levels are displayed using voltages residing between VF100b and VP0, there is an advantage that a shorter writing time can be achieved, although there are somewhat significant display irregularities in the intermediate gray levels and it is difficult to exercise control to suppress crosstalk with general-purpose driver ICs.

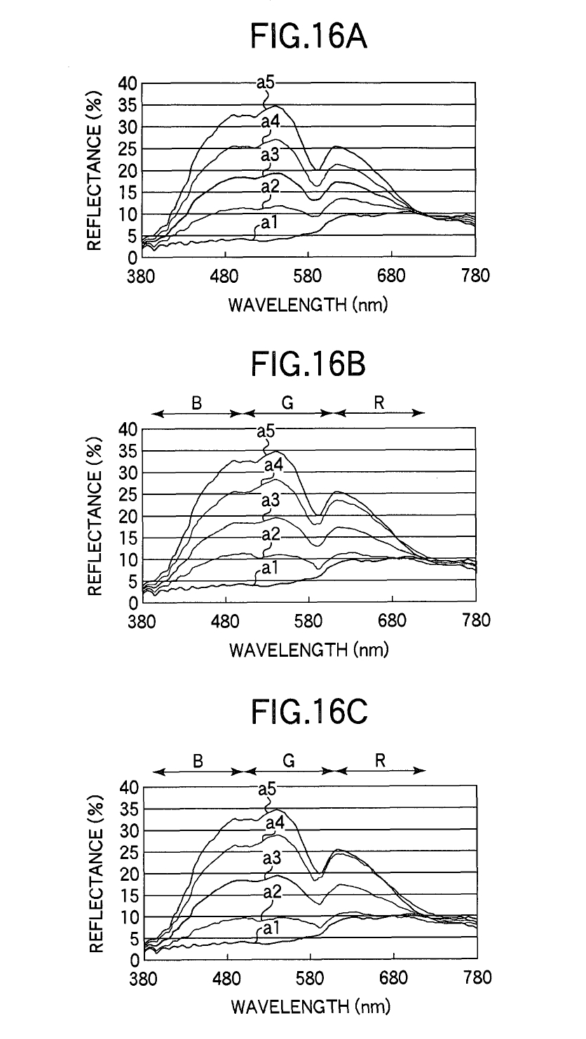

FIGS. 16A to 16C are graphs for explaining the effects of the present embodiment. FIG. 16A shows reflection spectra of grayscale display performed by a liquid crystal display element according to the related art. FIG. 16B shows reflection spectra of grayscale display performed by the liquid crystal display element of the present embodiment with gray level correction carried out based on the tone curves shown in FIG. 5. FIG. 16C shows reflection spectra of grayscale display performed by the liquid crystal display element of the present embodiment with gray level correction carried out based on the tone curves shown in FIG. 6. The curves a1 in FIGS. 16A to 16C represent reflection spectra in a state in which all of the three colors R, G, B are at gray level 0. Similarly, the curves a2, a3, a4, and a5 represent reflection spectra in states in which those colors are gray level 63, gray level 127, gray level 191, and gray level 255, respectively. For the liquid crystal display element of the present embodiment having the reflection spectra shown in FIGS. 16B and 16C, correction of gray levels based on the temperature in the vicinity of the display unit 38 was not performed.

As shown in FIG. 16A, in the liquid crystal display element according to the related art, reflectance in the long wavelength band corresponding to red is relatively high on the low gray level side and relatively low on the high gray level side. It will be understood that the element therefore has a reduction in the contrast and color purity of red. On the contrary, in the liquid crystal display element of the present embodiment, reflectance is kept low on the low gray level side (curve a2) of intermediate gray levels and increased on the high gray level side (curve a4) of the intermediate gray levels, in particular, in the longer wavelength band, as shown in FIGS. 16B and 16C. Especially, in the reflection spectra shown in FIG. 16C, reflectance in the short wavelength band corresponding to blue is kept low also on the low gray level side of the intermediate gray levels and increased on the high gray level side of the intermediate gray levels. It will be therefore understood that correction based on the tone curves shown in FIG. 6 allows higher contrast and color purity to be achieved.

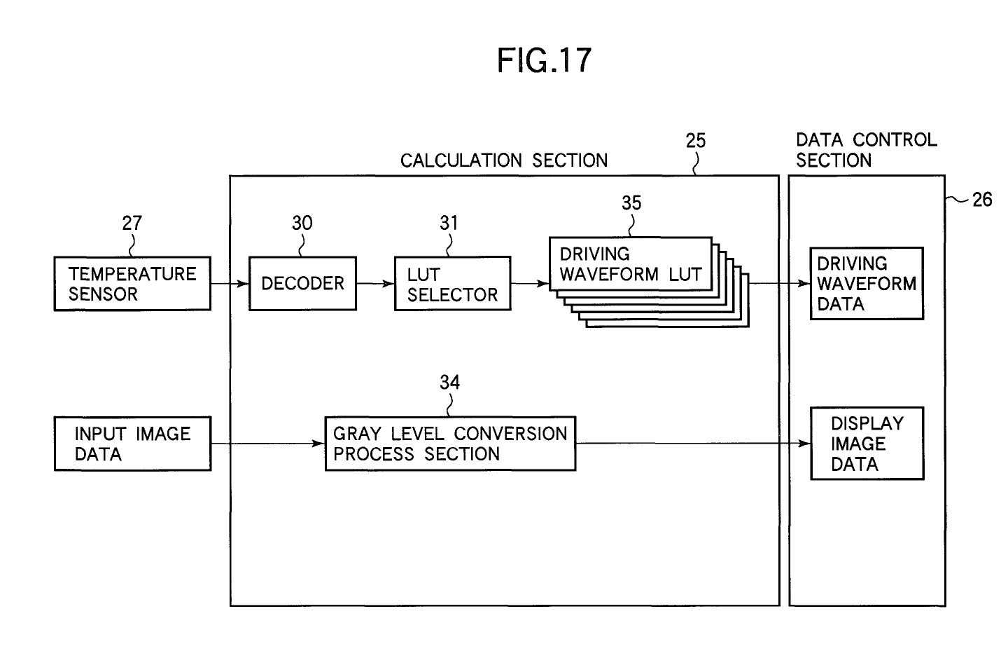

A modification of the liquid crystal display element of the present embodiment will now be described. The present modification is characterized in that data of driving waveforms is corrected instead of correcting display image data. FIG. 17 is a block diagram schematically showing a configuration of the calculation section 25 of the liquid crystal display element of the present modification and a flow of processes performed by the calculation section 25. As shown in FIG. 17, the calculation section 25 includes an LUT memory 35 for storing driving waveform LUTs instead of the LUT memory 32 for storing enhancement process LUTs. For example, data of waveforms of pulse voltages to be applied to liquid crystal layers of display layers 39R, 39G, and 39B to display an intermediate gray level is stored in a driving waveform LUT. Driving waveform data includes data of pulse widths and data of wave height correction values for correcting the height of pulse waves. For example, color components of a display layer of the liquid crystal display element have greater pulse widths and require greater wave height correction values on the high gray level side, the lower the display layer is located in the element. The color components of the display layer have smaller pulse widths and require smaller pulse height correction values on the low gray level side. The LUT selector 31 selects an optimal driving waveform LUT in the LUT memory 35 based on temperature data supplied from the decoder. The calculation portion 25 generates driving waveform data for each of the display layers 39R, 39G, and 39B based on the driving waveform LUT thus selected and outputs the data to the data control section 26.

Input image data is input to the gray level conversion process portion 34 of the calculation section 25. The gray level conversion process portion 34 performs a required gray level conversion process on the input data to generate display image data and outputs the display image data thus generated to the data control section 26. When the number of gray levels of each color in the input image data agrees with the number of gray levels that the display layers 39R, 39G, and 39B can display, the gray level conversion process portion 34 is not required. In that case, input image data is directly output to the data control section 26 as display image data.

Based on the driving waveform data for the display layers 39R, 39G, and 39B and the display image data, the data control section 26 generates driving data such that color components of a display layer of the liquid crystal display element will be more strongly enhanced in chroma and color purity, the lower the display layer is located in the element. The data control section 26 outputs the generated driving data to the driver ICs 21 on the data side according to the data fetching clock.

As described above, voltage values residing between VF0 and VF100a or voltage values residing between VF100b and VP0 are used to display intermediate gray levels. When intermediate gray levels are displayed using the voltage values between VF0 and VF100a, the initial state of the liquid crystal must be the planar state. Intermediate gray levels are displayed by applying pulse voltages having intensity between VF0 and VF100a to the liquid crystal layers in the planar state.

For example, when intermediate gray levels on the high gray level side (the driving voltages are in the range from 6 to 13 V as shown in FIG. 15) are to be enhanced, the liquid crystal is driven toward the planar state with wave height values corrected to provide relatively low output voltage values in order to make a correction in the direction of increasing brightness. On the contrary, when intermediate gray levels on the low gray level side (the driving voltages are in the range from 13 to 20 V as shown in FIG. 15) are to be enhanced, the liquid crystal is driven toward the focal conic state with wave height values corrected to provide relatively high output voltage values in order to make a correction in the direction of reducing brightness. That is, the driving data output by the data control section 26 includes driving voltage values corrected based on the wave height correction values for the driving waveform data instead of driving voltage values which are normally required for obtaining the display gray level values of the display image data. Further, pulse widths may be corrected instead of correcting the wave heights of pulse voltages. For example, increasing a pulse width has an effect substantially equal to the effect of increasing the voltage value.

When intermediate gray levels are displayed using voltage values residing between VF100b and VP0, the initial state of the liquid crystal may be either the planar state or focal conic state. Intermediate gray levels are displayed by applying pulse voltages having intensity between VF100b and VP0 to the liquid crystal layers.

For example, when intermediate gray levels on the high gray level side (the driving voltages are in the range from 29 to 32 V as shown in FIG. 15) are to be enhanced, the liquid crystal is driven toward the planar state with wave height values corrected to provide relatively high output voltage values in order to make a correction in the direction of increasing brightness. On the contrary, when intermediate gray levels on the low gray level side (the driving voltages are in the range from 26 to 29 V as shown in FIG. 15) are to be enhanced, the liquid crystal is driven toward the focal conic state with wave height values corrected to provide relatively low output voltage values in order to make a correction in the direction of reducing brightness.

In general, a reflective display element such as a liquid crystal display element employing a cholesteric liquid crystal has a limited color reproduction range. In the case of a display element according to the related art employing a cholesteric liquid crystal, colors such as human skin color can be considerably darkened when displayed, and such display of color has not been highly evaluated when tested on a subjective basis. The present embodiment was highly evaluated on a subjective basis because the embodiment makes it possible to enhance memorized colors such as skin color, greenery or the colors of sky which appeal to viewers.

As described above, the present embodiment makes it possible to improve the color reproducibility and contrast of a color displayed by a display layer, in particular, a display layer disposed in a low part of a color liquid crystal display element employing a cholesteric liquid crystal. The present embodiment allows high display quality to be achieved regardless of the temperature of the environment in which the liquid crystal display element is used.

The invention is not limited to the above-described embodiment and may be modified in various ways.

For example, the above embodiment has been described as a color liquid crystal display element employing a cholesteric liquid crystal by way of example. However, the invention is not limited to such an example and may be applied to other types of display elements.

In the above embodiment, a display element having a multi-layer structure formed by a plurality of liquid crystal layers has been described by way of example. The invention is not limited to such an example and may be applied to display elements having a single-layer structure.

Although electronic paper has been described by way of example in the above embodiment, the invention is not limited to the same and may be applied to various electronic terminals having a display element.

In the above embodiment, a description was made on a method in which input gray level values are simply converted into output gray level values based on fixed tone curves by way of example. The invention is not limited to such a method, and tone curves may be preferably optimized based on input image data. For example, a memorized color may be judged from input image data, and the memorized color may be enhanced over more strongly than other colors, which will result in higher subjective evaluation.

What is claimed is:

1. A liquid crystal display element, comprising:
a display unit having a first liquid crystal layer forming a cholesteric phase; and
a control unit generating first display image data to be displayed by the first liquid crystal layer by converting an input gray level value of input image data into a first display gray level value.

2. The liquid crystal display element according to claim 1, wherein the first display gray level value obtained by converting the input gray level value on a high gray level side is higher than the input gray level value.

3. The liquid crystal display element according to claim 1, wherein the first display gray level value obtained by converting the input gray level value on a low gray level side is lower than the input gray level value.

4. The liquid crystal display element according to claim 1, further comprising an ambient temperature detecting unit for detecting temperature in the vicinity of the display unit, wherein the first display gray level value obtained by converting the same input gray level value varies depending on the detected temperature.

5. The liquid crystal display element according to claim 4, wherein the first display gray level value obtained by converting the input gray level value on the high gray level side is higher, the lower the temperature is.

6. The liquid crystal display element according to claim 4, wherein the first display gray level value obtained by converting the input gray level value on the low gray level side is lower, the lower the temperature is.

7. The liquid crystal display element according to claim 1, wherein the display section further includes a second liquid crystal layer forming a cholesteric phase formed on a display surface side of the first liquid crystal layer, and wherein the control unit converts the input gray level value into a second display gray level value different from the first display gray level value, and further generates second display image data to be displayed by the second liquid crystal layer.

8. The liquid crystal display element according to claim 7, wherein the first display gray level value obtained by converting the input gray level value on the high gray level side is higher than the second display gray level value obtained by converting the input gray level value.

9. The liquid crystal display element according to claim 7, wherein the first display gray level value obtained by converting the input gray level value on the low gray level side is lower than the second display gray level value obtained by converting the input gray level value.

10. The liquid crystal display element according to claim 7, wherein the control unit includes a lookup table for storing each of the first and second display gray level values associated with the input gray level value.

11. The liquid crystal display element according to claim 7, wherein the control unit performs a calculation process using the input gray level value, and converts the input gray level value to each of the first and second display gray level values.

12. The liquid crystal display element according to claim 7, wherein the control unit performs a gray level conversion process on the generated first and second display gray level data when the number of gray levels in the input image data is different from the number of gray levels that the display unit can display.

13. The liquid crystal display element according to claim 7, wherein the control unit generates the first and second display image data after performing the gray level conversion process on the input image data when the number of gray levels in the input image data is different from the number of gray levels that the display unit can display.

14. The liquid crystal display element according to claim 7, wherein the display unit includes a third liquid crystal layer forming a cholesteric phase formed on a display surface side of the second liquid crystal layer, and wherein the control unit converts the input gray level value into a third display gray level value different from at least either of the first and second display gray level values, and generates third display image data to be displayed by the third liquid crystal layer.

15. The liquid crystal display element according to claim 14, wherein the first liquid crystal layer reflects red light in a planar state, the second liquid crystal layer reflects green light in the planar state, and the third liquid crystal layer reflects blue light in the planar state.

16. A liquid crystal display element comprising:
a display unit having a first liquid crystal layer forming a cholesteric phase and a second liquid crystal layer forming a cholesteric phase formed on a display surface side of the first liquid crystal layer; and
a control unit for generating first driving waveform data of a pulse voltage applied to drive the first liquid crystal layer based on input image data and generating second driving waveform data of a pulse voltage applied to drive the second liquid crystal layer based on the input image data.

17. The liquid crystal display element according to claim 16, wherein the first and second driving waveform data includes pulse width data, and the pulse width of the first driving waveform data is different from the pulse width of the second driving waveform data.

18. The liquid crystal display element according to claim 16, wherein the first and second driving waveform data includes data of wave height correction values for correcting pulse wave heights, and the wave height correction value of the first driving waveform data and the wave height correction value of the second driving waveform data are different from each other.

19. Electronic paper comprising a liquid crystal display element according to claim 1.

20. An image processing method comprising the steps of:
converting an input gray level value of input image data into a first display gray level value, and generating first display image data to be displayed by a first liquid crystal layer; and
converting the input gray level value into a second display gray level value different from the first display gray level value, and generating second display image data to be displayed by a second liquid crystal layer formed on a display surface side of the first liquid crystal layer.
